(19) United States
(12) Patent Application Publication
(10) Pub. No.: US 2015/0074656 A1
(43) Pub. Date: Mar. 12, 2015

(54) Preconfigured Application Install

(71) Applicant: David Eramian, San Jose, CA (US)

(72) Inventor: David Eramian, San Jose, CA (US)

(21) Appl. No.: 14/024,303

(22) Filed: Sep. 11, 2013

(51) Int. Cl. G06F 9/445

(52) U.S. Cl. CPC G06F 8/65
USPC 717/168

(57) ABSTRACT

Embodiments of systems and methods are provided for configuring applications with one or more features based on a user's needs or preferences. In an embodiment, a system comprises one or more processors and one or more memories adapted to store a plurality of machine-readable instructions which when executed by the one or more processors are adapted to cause the system to: analyze information about a user and/or a user device to determine one or more features of an application that are preferable to the user; and configure the application with the one or more features based on the analyzed information about the user and/or the user device.

### BACKGROUND

1. Technical Field

Embodiments of the present disclosure generally relate to applications for user devices, and more particularly, to methods and systems for configuring features of applications when they are installed on user devices.

2. Related Art

Currently, applications may be downloaded or installed on user devices for various purposes in many contexts. Applications may be very useful and facilitate a user's device experience. However, applications today may generally have one simplified or “one size fits all” interface wherein the applications are generally installed with stock settings, which may not be suitable for every user. As a result, when applications are purchased or installed, users may be required to adjust or change the stock settings for each application according to the user's needs or preferences. For example, people with poor eyesight may need to change a stock setting such as from a regular size font to a larger size font. Some users such as elderly users or those with less technological experience may find it difficult to adjust or change the stock settings of an application, and thus, may be less inclined to use the application.

### BRIEF DESCRIPTION OF THE FIGURES

FIG. 1 illustrates a system for pre-configuring features of applications according to an embodiment of the present disclosure.

FIG. 2 is a flow diagram illustrating a method for pre-configuring features of applications according to an embodiment of the present disclosure.

FIG. 3 is a block diagram illustrating a system for implementing a device according to one embodiment of the present disclosure.

Like element numbers in different figures represent the same or similar elements.

### DETAILED DESCRIPTION

In accordance with various embodiments described herein, methods and systems are provided for configuring features of applications such that a user of a user device may not have to change any features or otherwise do any additional configuration of the applications to meet the user's needs or preferences. At any time such as when an application is being installed on the user device, or before or up to the point when the user engages or uses the features of the application, the user device's operating system may configure one or more features of the application based on information such as information about the user and/or the user device.

In one or more embodiments, the user device's operating system may analyze information about the user and/or the user device to determine certain configurations of an application that may be preferable to the user. The analyzed information may include settings of other installed applications, previous user device behavior, medical records of the user (e.g., cataracts, near-sightedness, glaucoma, etc. to the extent such medical records are accessible in accordance with various laws including HIPPA), previous transactions completed for example via a payment service provider such as PayPal®, Inc. of San Jose Calif., segments or groups to which the user may belong, and any other relevant information.

In various embodiments, the user device (and consequently the user) may be identified. Application features may then be configured according to the identified user device or user. In general, different users may require or prefer different application features. In this regard, application features may be configured to meet different needs or preferences of a group or segment of users. That is, application features may be configured based on different levels or granularity according to, for example, one or more population segments, demographics, etc. to which the user may belong including age, gender, income, educational level, medical conditions, geographic location, etc. For example, aged users (e.g., geriatric users such as users over 65 years old) may require or prefer different application settings than teenagers, based at least in part upon one or more factors including, but not limited to, differences in dexterity, sight, hearing, color preferences, type of device used, and preferred type of notification (e.g., e-mail, SMS, MMS, etc.).

Advantageously, in embodiments herein, instead of applications being installed on a user device with “one size fits all” or factory setting features, the applications may be automatically preconfigured at any time such as when they are installed, or before or up to the point where a particular user fully engages or uses an application so that the particular user may not have to change any settings or do any additional configuration of the applications to meet the user's needs or preferences. As a result, the user may be more likely to use or engage with the application.

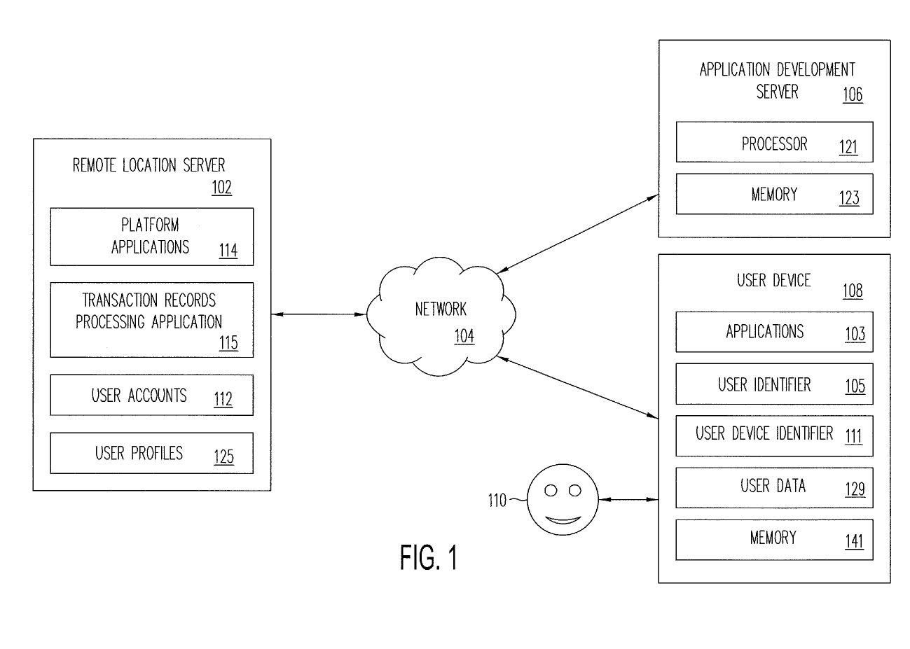

Referring now to the drawings wherein the showings are for purposes of illustrating embodiments of the present disclosure only, and not for purposes of limiting the same, FIG. 1 illustrates a system for pre-configuring features of applications according to an embodiment of the present disclosure.

A remote location server 102 is adapted to communicate or exchange data with an application development server 106 and a user device 108 and correspondingly a user 110 (also referred to as a “customer” or “consumer”), via a network 104. Data connections between remote location server 102 and application development server 106 and user device 108 may take place, for example, via SMS or a Wireless Application Protocol (WAP) over network 104. In addition, according to one or more embodiments, remote location server 102 may have other data connections (not shown), for example, with subscriber Internet companies, Internet financial companies, Internet brokers or other Internet companies. In one embodiment, remote location server 102 may be implemented by a payment service provider such as PayPal®, Inc., or eBay®, Inc. of San Jose, Calif., USA.

Application development server 106 includes one or more processors 121 coupled to one or more memories 123 configured to process creation and/or deployment of applications by application developers to be downloaded by one or more users such as user 110 on user device 108. The application developer may be any entity, for example an individual or a corporation, which develops one or more applications or portions thereof, for example a software application, operable on different types of user devices. Examples of application developers include iTunes®, Sprint®, Tivo®, Wii®, Playstation®, or the like. The application developer may be known or unknown to the manufacturer of user device 108.

According to an embodiment, user device 108 may be configured to download, install, and run applications (e.g. in Applications 103) created and/or deployed by application development server 106. Also, a platform application 114 of remote location server 102 may be configured to interact with user 110 (via user device 108) so that user device 108 is enabled to download applications (e.g. in Applications 103) from application development server 106 or from remote location server 102. In one or more embodiments herein, at any time such as when an application is installed on user device 108 or before or up to the point when user 110 engages the features of an application installed on user device 108, features of the application may be preconfigured to meet user's 110 particular needs or preferences as will be described in more detail below.

In various embodiments, a user such as user 110 may register, sign up, or otherwise install applications from remote location server 102 via platform application 114 in order to conduct transactions such as purchasing items, bidding, etc. Remote location server 102 may maintain a plurality of user accounts 112, each of which may include account information associated with specific users such as user 110. For example, in one embodiment, account information may include private or confidential information of a user such as account numbers, passwords, credit/debit card information, bank information, or other information that may be used to facilitate online or other types of transactions between remote location server 102 and users. In the system for pre-configuring features of an application according to an embodiment, a transaction using user device 108 and remote location server 102 may generate certain data associated with the user or the user device so that applications installed by user 110 may be configured according to the user's liking.

In that regard, remote location server 102 may receive registration information from user 110 using user device 108 to open a user account 112. It should be appreciated that user 110 may provide account information to remote location server 102 over network 104 through, for example, a secure connection between user device 108 and remote location server 102. For example, in one embodiment, remote location server 102 may provide a webpage that may be viewed by a user through a browser application.

As a result of such registration, remote location server 102 may assign, and user device 108 may store, a specific user identifier 105 that may be used to identify the particular user as having a user account 112 maintained by remote location server 102. The user identifier may be implemented, for example, as one or more cookies, operating system registry entries, hardware identifiers, or other types of identifiers. Other data specific to the user may be created and stored by remote location server 102, including for example, signature information and a user profile 125. User profile 125 may be created, for example, based on a user's typical behavior in transactions including, but not limited to, for example, the type of items the user purchases, time at which the user normally shops, merchants favored by the user, websites frequently accessed by the user, typical locations of the user, etc. Furthermore, user information or data included in user device 108, for example, contact lists, calendar, location information, medical records, etc., may be stored in user data 129 of user device 108 and/or in remote location server 102, for example, in user profile 125.

In an embodiment, user device information or data such as type of device or phone model may be received from a communications service provider such as a cell phone provider and stored by remote location server 102 or in a memory 141 of user device 108, for example. In other embodiments, user information or data of user device 108 such as location, medical records, identifiers, etc., may be extracted via software tools. In further examples, a user may input data or information directly into his or her user device as may be appropriate, for example, a user may input the type of device or platform settings that the user is using; for instance, the user may input information for his or her social network. In another example, the user's device or platform, e.g., phone model, may be determined via a user device identifier 111 such as a phone number or other identifiers specifically associated with the user device or platform.

Remote location server 102 may provide a transaction records processing application 115 that may be configured to receive transaction information from user device 108 over network 104 and store the transaction information in a plurality of transaction records that are associated with individual user accounts 112, or in a corresponding user profile 125. Also, transaction records may be implemented to store transaction information associated with particular applications, for example online, NFC or other types of downloaded applications, between user device 108 or user 110 and application developer server 106. Access to transaction records may be controlled by remote location server 102, for example, to prevent the storage or retrieval of the transaction records by other parties without the permission of user 110. In this regard, remote location server 102 may require the receipt of a security identifier such as a valid password, a user identifier, a username, and/or other appropriate information before transaction records may be stored, changed, and/or retrieved. It will be appreciated that by performing a plurality of transactions by user 110 with remote location server 102 and/or application development server 106, a plurality of transaction records may be stored by remote location server 102, for example in user profiles 125 and may be associated with an appropriate user account 112, which is associated with user 110.

The centralized storage of transaction information or data of remote location server 102 may be combined and enhanced with data obtained from business partners of remote location server 102 including subscriber acquirers, brands, Internet companies, or other entities. In one embodiment where remote location server 102 is PayPal®, Inc., the centralized stored transaction data may be combined with data obtained from PayPal®'s business partners such as eBay®, RedLaser®, etc., thus resulting in even richer and more extensive data. The centralized data storage capabilities of remote location server 102 may facilitate both a rule-based system and behavioral engine that may generate user data models based on such rich and extensive data. Remote location server 102 is able to offer and provide a service that may work in real time to identify information and data associated with application development server 106 and user device 108 to enable configuration of application features associated with particular users.

User device 108 may be implemented using any appropriate combination of hardware and/or software configured for wired and/or wireless communication over a network. For example, in one embodiment, user device 108 may be implemented as a mobile device of user 110 in communication with network 104 such as the Internet or another network. In other embodiments, user device 108 may be implemented as a personal computer, tablet, wireless telephone, personal digital assistant (PDA), key fob, smart phone, smart card, notebook computer, game console, digital video recorder (DVR), and/or other types of computing devices. Furthermore, user device 108 may be enabled for NFC, Bluetooth, online, infrared communications and/or other types of communications.

User device 108 may include various applications, for example in Applications 103, as may be desired in particular embodiments to provide desired features to user device 108. For example, in various embodiments, applications may include security applications for implementing client-side security features, programmatic client applications for interfacing with appropriate application programming interfaces (APIs) over a network, or other types of applications.

User device 108 may further include a user device identifier 111 that includes user device identification information such as, for example, a Secure Element (SE) number or identification (ID), the user device's unique identifier number such as an International Mobile Equipment Identity (IMEI) number, or a unique number associated with a user of a user device such as an International Mobile Subscriber Identity (IMSI) number, which may be stored inside the user device, for example, in a component such as an SE, a UICC/SIM card, a smart card or any other suitable card of the user device.

User device 108 may further include one or more user identifiers 105 that may be implemented, for example, as operating system registry entries, cookies associated with a browser application, identifiers associated with hardware of user device 108, or other appropriate identifiers. In one embodiment, a user identifier may be used by remote location server 102 to associate user device 108 or user 110 with a particular account maintained by remote location server 102.

In various embodiments, user data 129 or memory 141 of user device 108 may store user profiles or information related to the specific user such as medical records or history (e.g., cataracts, near-sightedness, glaucoma, etc. to the extent this information is accessible in accordance with various laws including HIPAA), settings or preferences for various applications installed on the user device, transaction data including previous transactions completed via remote location server 102 (e.g., a payment service provider such as PayPal®), previous device behavior, or any other information relevant to the particular user's needs or preferences. In an embodiment, user device 108 may enrich the information stored in user database 129 with at least a portion of centralized data stored in remote location server 102.

User device 108, application developer server 106, and remote location server 102 may each include one or more processors, memories, and other appropriate components for executing instructions such as program code and/or data stored on one or more computer readable mediums to implement the various applications, data, and methods described herein. For example, such instructions may be stored in one or more computer readable mediums such as memories or data storage devices internal and/or external to various components of the system, and/or accessible over a network, which may be implemented as a single network or a combination of multiple networks. For example, in various embodiments, network 104 may include the Internet or one or more intranets, landline networks, wireless networks, and/or other appropriate types of networks.

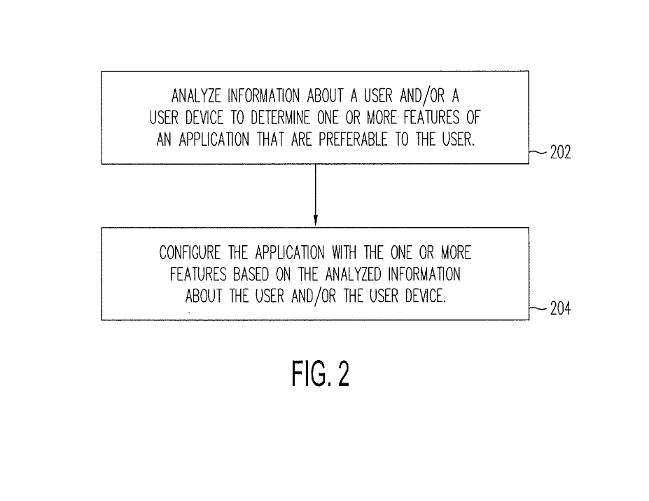

FIG. 2 is a flow diagram illustrating a method for pre-configuring features of applications according to an embodiment of the present disclosure. It should be noted that the method of FIG. 2 may be implemented by the system illustrated in FIG. 1 according to one or more embodiments. Also, it should be noted that pre-configuring or configuring features of an application may refer to or be viewed as configuring an application with specific features preferable to the user such as configuring the application with a larger font setting, a higher brightness level than factory settings, etc.

In block 202, information about a user and/or a user device may be analyzed to determine one or more features of an application that may be preferable to the user. In one or more embodiments, user inputs may be received on the user device selecting an application for installing on the user device, wherein the application is operable on one or more application platforms. At any time including at the time when an application is installed on the user device, or before or up to when the user engages one or more features of the application, etc., the operating system of the user device may analyze information related to the user such as user preferences or needs. For example, analyzed information may include settings of other installed applications (which may include all installed applications, applications commonly or recently used by the user, applications with similar functionality or type as the current application (e.g., applications for games, messaging, shopping, etc.), applications in which the user has changed factory or stock settings, etc.), previous user device behavior, medical records of the user, previous transactions completed with a remote location server such as a payment provider server (e.g., PayPal®), groups or segments to which the user may belong, etc.

In an embodiment, as a result of a user's registration with a remote location server such as remote location server 102 (illustrated in FIG. 1), the remote location server may assign, and the user device may store, a specific user identifier that may be used to identify the particular user as having a user account maintained by remote location server. Data specific to the user may be created and stored by the remote location server, including for example, signature information and a user profile, which may be created, for example, based on a user's typical behavior in transactions. Furthermore, user data included in the user device 108, for example, contact lists, calendar, medical records, locations visited, personal information etc., may be stored in a memory of the user device and/or in remote location server 102. In another example, user data including a user device identifier such as type of device or phone model may be received from a communications service provider such as a cell phone provider and stored by remote location server or in a memory such as memory 141 of user device 108 illustrated in FIG. 1.

In one embodiment, for example when a user downloads an application from an application store or application development server, the user device (and consequently the user) may be identified. As described above according to one or more embodiments, the user device may be identified, for example, by one or more identifiers specific to the user device. For example, by using the user device's identification information such as a Secure Element number or identification (ID), the user device's unique identifier number such as an IMEI number, or a unique number associated with a user of a user device such as an IMSI number.

In block 204, the application may be configured with one or more features based on the analyzed information about the user and/or the user device. That is, features such as settings for an application may be configured according to the user's needs or preferences. Instead of the application being installed with factory or stock settings, which may not be suitable for every user, the needs or preferences of the user may be taken into account to configure the settings.

In an example, at any time including when an application is being installed on a user device, or before or up to when a user of the user device engages one or more features of the application, etc., analyzed information about the user and/or the user device may indicate that the user has poor eyesight. In that regard, the user device and consequently the user may be identified via a user device identifier such as the user device's IMEI number, IMSI number, etc. Also, information stored in the user device or in a user profile 125 of remote location server 102 (illustrated in the embodiment of FIG. 1) may be analyzed regarding the user's eye health such as medical records, transaction data related to eye medications, eye doctor offices, insurance companies, etc. Furthermore, information about other applications installed on the user device may indicate that settings for those other applications may include a larger-font setting (e.g., a 16 font size versus a regular 12 font size). Based on such information, it may be determined that the user is likely to have poor eyesight and may need to use a larger font size. As a result, a new application may be automatically configured to meet the user's needs such as a larger font size. Advantageously, users may avoid having to change stock settings such as a font size for new applications.

In one or more embodiments, applications may be pre-configured or configured with one or more features according to different levels or granularity based on needs or preferences of certain groups or population segments. In one example, application settings may be configured differently for older users (e.g., a senior citizen or geriatric user, such as a user that is older than 75 years old) than for teenagers. In other examples, settings may be configured differently based on population segments such as gender, income levels, education levels, geographical locations, or other demographics. For example, a user device (and consequently the user) may be identified (e.g., via its IMEI, IMSI number, etc.) along with user data including transaction data (e.g. via a remote location server), user device information such as particular settings of other applications, location, demographics data, etc. Analysis of these data may indicate that the particular user of the identified user device is over 65 years old, and lives in a retirement community. Based on this analysis, certain application configurations may apply, for example, configurations for a segment of users that are over 65 years old, which may include, for example, a certain larger font, a louder audio level, etc.

In an embodiment where an application from a particular application developer or entity has been previously downloaded, and a new application is being downloaded from the same application developer or from a business partner of the application developer or entity, information about the features of the previously downloaded application may be used to configure the features of the new application. That is, a passive or background configuration may be seamlessly performed for the new application based on other applications on the user device. As such, information about the user device (and user) as well as any stored information about applications downloaded therein may be analyzed to subsequently configure new application features. In an example, a user device having an eBay® application previously downloaded therein, which later downloads a PayPal® application (or an application from any other company related to eBay®), may use the preexisting eBay® application settings to configure the PayPal® application settings upon installation or at any other appropriate time.

As described above according to one or more embodiments, a new application may be configured in a manner that may be preferable to a user based on user or user device information such as demographic information including age, gender, income, etc., medical records, transaction data including number of transactions, transactions via an entity or business partners, items purchased, etc., geographic information, other applications downloaded on the user device, and the like. As such, the new application may be automatically personalized or tailored to the user's preferences or needs without the user having to change any features or stock settings.

Although various components and steps have been described herein as being associated with user device 108, application development server 106, and remote location server 102 of FIG. 1, it is contemplated that the various aspects of such servers illustrated in FIG. 1 may be distributed among a plurality of servers, devices, and/or other entities. For example, in one embodiment, transaction record processing application 115 may be implemented by an entity separate from remote location server 102. Accordingly, in such an embodiment, communications described herein performed in relation to transaction record processing application 115 may be provided to a separate entity and need not be routed through remote location server 102 in all instances.

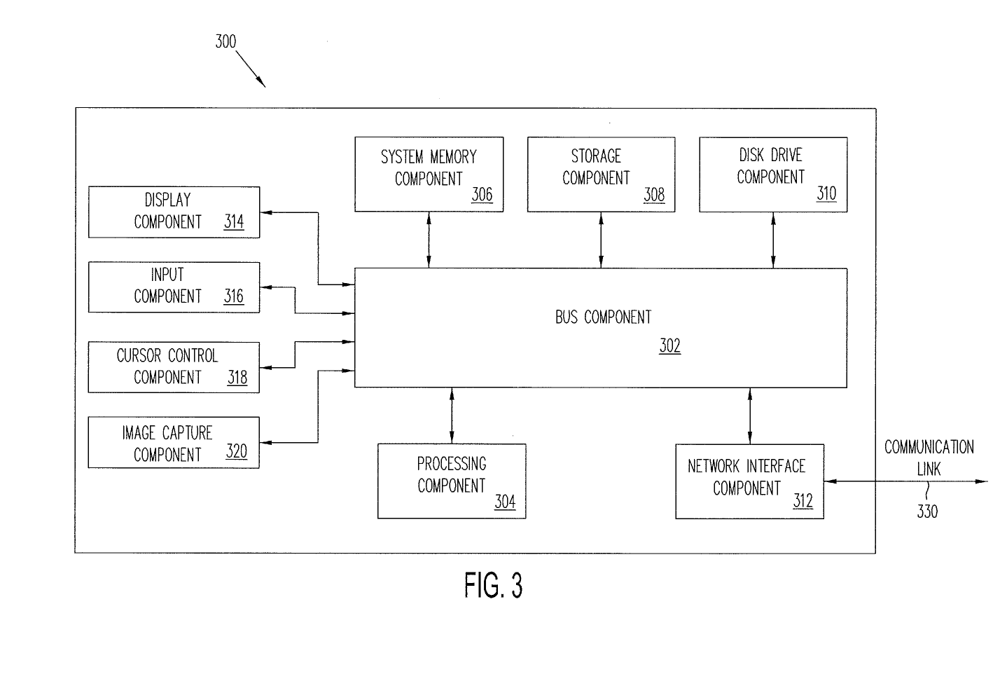

Referring now to FIG. 3, a block diagram of a system for implementing a device is illustrated according to one embodiment of the present disclosure.

FIG. 3 is a block diagram of a system 300 suitable for implementing embodiments of the present disclosure, including user device 108, application development server or device 106, and remote location server 102 or device. System 300, such as part of a mobile phone, tablet, personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., touchpad, keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to create accounts, process applications, configure applications, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for application processing, payments, financial transactions or other transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 104 of FIG. 1, LAN, WLAN, PTSN, or various other wired or wireless networks) may perfoini instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

Where applicable, various embodiments provided by the present disclosure may be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure. Thus the disclosure is limited only by the claims.

What is claimed is:

1. A system comprising:
one or more processors; and
one or more memories adapted to store a plurality of machine-readable instructions which when executed by the one or more processors are adapted to cause the system to:
analyze information about a user and/or a user device to determine one or more features of an application that are preferable to the user; and
configure the application with the one or more features based on the analyzed information about the user and/or the user device.

2. The system of claim 1, wherein the plurality of machine-readable instruction which when executed by the one or more processors further cause the system to: receive an input comprising a selection of an application to be installed on the user device, wherein the application is operable on one or more application platforms.

3. The system of claim 1, wherein the plurality of machine-readable instruction which when executed by the one or more processors further cause the system to: determine identification information of the user device and consequently the user to personalize the feature(s) of the application based on the identification information of the user device and consequently the user.

4. The system of claim 3, wherein the plurality of machine-readable instruction which when executed by the one or more processors further cause the system to: determine the identification information of the user device based on the analyzed information, wherein the analyzed information further comprises user device identifier information including a phone number, a Secure Element (SE) number or identification (ID), an International Mobile Equipment Identity (IMEI) number, an International Mobile Subscriber Identity (IMSI) number, or a unique identifier specifically associated with the user device.

5. The system of claim 1, wherein the analyzed information further comprises at least one of demographic information including age, gender, income; medical records; transaction data including a number of transactions, transactions via an entity or business partners, items purchased; geographic information; and other applications downloaded on the user device.

6. The system of claim 1, wherein the plurality of machine-readable instructions which when executed by the one or more processors further cause the system to: extract the information about the user or the user device via software tools.

7. The system of claim 1, wherein the plurality of machine-readable instructions which when executed by the one or more processors further cause the system to: directly receive user inputs comprising the information about the user or the user device.

8. The system of claim 1, wherein the analyzed information further comprises data maintained at a remote location server in a user profile associated with the user.

9. The system of claim 1, wherein the plurality of machine-readable instructions which when executed by the one or more processors are adapted to cause the system to:
configure the application with the one or more features of at a time including when an application is being installed on the user device, or before or up to a time when the user engages or uses the feature(s) of the application.

10. The system of claim 1, wherein the plurality of machine-readable instructions which when executed by the one or more processors are adapted to cause the system to:
identify the user device and consequently the user as belonging to a specific group or segment of users; and
configure the application with the one or more features according to needs or preferences of the specific group or segment of users.

11. The system of claim 10, wherein the specific group or segment of users is based at least in part on one of age, gender, income, educational level, medical information and geographical location.

12. A method comprising:
analyzing, electronically by a processor, information about a user and/or a user device to determine one or more features of an application that are preferable to the user; and
configuring, electronically by the processor, the application with the one or more features based on the analyzed information about the user and/or the user device.

13. The method of claim 12, further comprising: determining identification information of the user device and consequently the user to personalize the feature(s) of the application based on the identification information of the user device and consequently the user.

14. The method of claim 13, wherein the determining the identification information of the user device further comprises determining the identification information based on the analyzed information, wherein the analyzed information further comprises user device identifier information including a phone number, a Secure Element (SE) number or identification (ID), an International Mobile Equipment Identity (IMEI) number, an International Mobile Subscriber Identity (IMSI) number, or a unique identifier specifically associated with the user device.

15. The method of claim 12, wherein the analyzed information further comprises at least one of demographic information including age, gender, income; medical records; transaction data including a number of transactions, transactions via an entity or business partners, items purchased; geographic information; and other applications downloaded on the user device.

16. The method of claim 12, wherein the analyzed information further comprises data maintained at a remote location server in a user profile associated with the user.

17. The method of claim 12, wherein the configuring further comprises configuring the application with the one or more features at a time including when an application is being installed on the user device, or before or up to a time when the user engages or uses the feature(s) of the application.

18. The method of claim 12, further comprising:
identifying the user device and consequently the user as belonging to a specific group or segment of users; and
configuring the application with the one or more features according to needs or preferences of the specific group or segment of users.

19. The method of claim 18, wherein the specific group or segment of users is based at least in part on one of age, gender, income, educational level, medical information and geographical location.

20. A non-transitory computer readable medium on which are stored computer readable instructions and, when executed by a processor, cause the processor to:
analyze information about a user and/or a user device to determine one or more features of an application that are preferable to the user; and
configure the application the one or more features of based on the analyzed information about the user and/or the user device.
